(19) United States
(12) Patent Application Publication
(10) Pub. No.: US 2024/0087252 A1
(43) Pub. Date: Mar. 14, 2024

(54) METHOD AND SYSTEM FOR GENERATING AUGMENTED REALITY CONTENT USING AR/VR DEVICES

(71) Applicant: SAMSUNG ELECTRONICS CO., LTD., Suwon-si (KR)

(72) Inventors: Sujoy SAHA, Bangalore (IN); Rajas Jayant JOSHI, Nagpur (IN); Rajat Kumar JAIN, Pune (IN); Aditi SINGHAL, Meerut Cantt (IN); Amita BADHWAR, Phagwara (IN); Sathyanarayanan KULASEKARAN, Bangalore, IN (US); Sarthak SENGUPTA, Ghaziabad (IN); Lokesh Rayasandra BOREGOWDA, Bangalore (IN)

(73) Assignee: SAMSUNG ELECTRONICS CO., LTD., Suwon-si (KR)

(21) Appl. No.: 18/244,043

(22) Filed: Sep. 8, 2023

(30) Foreign Application Priority Data
Sep. 9, 2022 (IN) 202241051677
Jul. 10, 2023 (IN) 202241051677

(51) Int. Cl. G06T 19/00

(52) U.S. Cl. CPC G06T 19/006; G06T 2219/024

(57) ABSTRACT

Provided is a method for generating Augmented Reality (AR) content that includes: receiving a plurality of image frames of at least one scene captured by a plurality of participant devices in an AR or a Virtual Reality (VR) environment; storing the plurality of image frames and metadata associated with the plurality of image frames, in a database; receiving an AR content generation request to generate an AR content view of a user in the AR/VR environment, the AR content generation request including an identifier (ID) of the user and information of the at least one scene; retrieving a set of image frames from a plurality of stored image frames in the database based on the ID of the user, the information of the at least one scene, and metadata associated with the set of image frames, the set of images including the user in the at least one scene in the AR/VR environment; generating the AR content view of the user by combining the set of image frames retrieved from the database, based on the metadata associated with the set of image frames; and displaying the AR content view.

### CROSS-REFERENCE TO RELATED APPLICATION(S)

This application is based on and claims priority under 35 U.S.C. § 119 to Indian Provisional Application No. 202241051677, filed on Sep. 9, 2022, and Indian Complete Application No. 202241051677, filed on Jul. 10, 2023, in the Indian Patent Office, the disclosures of which are incorporated by reference herein in their entireties.

### BACKGROUND

### 1. Field

The disclosure relates to an Augmented Reality (AR) system, and more specifically to a method and a system for generating Augmented Reality (AR) content using a plurality of participant devices.

### 2. Description of Related Art

AR devices are wearable computer-capable devices that add extra information, ideally Three-Dimensional (3D) images and information such as animations and videos, to a user's real-world scenes by overlaying computer-generated or digital information on the user's real-world. In an AR scenario, where the user wearing the AR device e.g., a head mounted AR Glass/ Head Mounted Device (HMD) is attending an event e.g., a party or a celebration with friends and family, it is neither convenient nor technically compatible to use a separate smart phone or a camera to capture an AR event, as the separate smart phone or the camera cannot capture AR elements.

Furthermore, the user may wish to relive certain experiences from the event. In such cases, the user views only recordings captured by his/her head mounted AR Glass/HMD to revisit those events. However, the captured recordings present a first-person perspective of the event and fail to display the emotions of the user. Thus, there is a gap when it comes to capturing the event memories for AR experiences in the related art.

The related art provides for an information processing apparatus including a perspective switching control unit configured to switch a perspective when playing back content acquired by a content acquisition unit to at least one of a first-person perspective and a third-person perspective. An editing unit is configured to edit a part of the content. A playback control unit is configured to play back the content edited by the editing unit in the at least one of the first-person perspectives and the third-person perspective to which the perspective has been switched by the perspective switching control unit. However, the related art fails to disclose creation of a third person view using camera feeds from one or more participants. The related art also fails to disclose use of an Ultra-wideband (UWB) sensor or a Simultaneous localization and mapping (SLAM) engine to obtain positional and location information to create the third person view of the user. The related art also fails to create a database having image frames with correlated parameters.

The related art provides for a space interaction AR realization method and system based on multi-person visual angle positioning that includes following steps: acquiring a visual angle, a position and a behavior action of a plurality of users in a real space, and assigning parameters corresponding to the visual angle, the position and the behavior action to a three-dimensional virtual rendering engine. The three-dimensional virtual rendering engine creates a virtual space or a virtual object according to the acquired data attribute. The virtual space or the virtual object which is created through rendering is sent to an AR glasses equipment worn by multiple persons. According to an optical visual imaging of the AR glasses, a real object in the real space and a virtual object in the virtual scene created by rendering of the three-dimensional virtual engine are superposed and fused. However, the related art fails to disclose the UWB sensor or the SLAM engine to obtain positional and location information to create the third person view of the user. The related art also fails to create the database having image frames with correlated parameters.

### SUMMARY

Provided are a method and a system for generating Augmented Reality (AR) content using participant devices. The method and system address the above-mentioned disadvantages or other shortcomings in the related art, or at least provide a useful alternative to capture event memories and display emotions of a user by generating AR content. The method and system provide for the user to create a view from different perspectives and generate three-dimensional (3D) content. The method and system also provide for the user to review his interaction with an AR object and help to recollect the discussions that took place at a particular event in a more efficient manner. The user may analyze their personality and notice their behavior during that particular event (e.g., a presentation) and work on self-improvement effectively.

Example embodiments of the disclosure aggregate the camera feeds and/or the image frames using location information and dynamic positioning information of each participant device.

Example embodiments of the disclosure generate a database having a correlation of one or more parameters of the participant devices, and the dynamic positions of the participant devices. The parameters of the participant devices include, but are not limited to, scene elements in the image frames, actions of the scene elements in the image frames, and location information of the scene elements.

Example embodiments of the disclosure generate a map of the user and surrounding environment of the user, and enable the user to experience and re-imagine their memories in a user-friendly manner.

According to an aspect of the disclosure, a method for generating Augmented Reality (AR) content includes: receiving, by an AR system, a plurality of image frames of at least one scene captured by a plurality of participant devices in an AR environment or a Virtual Reality (VR) environment (AR/VR environment); storing, by the AR system, the plurality of image frames and metadata associated with the plurality of image frames, in a database; receiving, by the AR system, an AR content generation request to generate a third person AR content view of a user in the AR/VR environment, the AR content generation request including an identifier (ID) of the user and information of the at least one scene; retrieving, by the AR system, a set of image frames from a plurality of stored image frames in the database based on the ID of the user, the information of the at least one scene, and metadata associated with the set of image frames, the set of images including the user in the at least one scene in the AR/VR environment; generating, by the AR system, the third person AR content view of the user by combining the set of image frames retrieved from the database, based on the metadata associated with the set of image frames; and displaying, by the AR system, the third person AR content view.

The information of the at least one scene may include at least one of a scene ID, a scene tag, a scene description, a time stamp associated with a scene, and location information of the at least one scene.

The metadata may include at least one of device IDs of the plurality of participant devices, participant IDs of a plurality of participants identified in the plurality of image frames, location information and geo-location information associated with the plurality of participant devices, and privacy keys of the plurality of participants.

The privacy keys of the plurality of participants may be used to authenticate the user for managing content in the database.

The method of retrieving, by the AR system, the set of image frames from the plurality of stored image frames in the database may include: detecting, by the AR system, the ID of the user, the information of the at least one scene, and the metadata associated with the plurality of image frames captured by the plurality of participant devices; determining, by the AR system, a correlation between the information of the at least one scene and the metadata associated with the plurality of image frames based on the ID of the user; and retrieving, by the AR system, the set of image frames from the database based on the ID of the user and the correlation between the information of the at least one scene and the metadata associated with the plurality of image frames.

The method of generating, by the AR system, the third person AR content view of the user may include: authenticating, by the AR system, the received AR content generation request received from the user; based on authenticating the received AR content generation request, collecting, by the AR system, the set of image frames from the database; and combining, by the AR system, the set of image frames based on the metadata associated with the set of image frames to generate the third person AR content view of the user.

According to an aspect of the disclosure, a system for generating Augmented Reality (AR) content includes: a plurality of participant devices; an AR device or Virtual Reality (VR) device (AR/VR device); and a server. The AR/VR device includes: a communicator; an image management controller; a memory storing at least one instruction; and at least one processor operatively connected to the communicator, the image management controller, and the memory, the at least one processor configured to execute the at least one instruction to: receive a plurality of image frames of at least one scene captured by the plurality of participant devices in an AR/VR environment, and store the plurality of image frames and metadata associated with the plurality of image frames in a database. The server is configured to: receive an AR content generation request to generate a third person AR content view of a user in the AR/VR environment, the AR content generation request including an identifier (ID) of the user and information of the at least one scene, retrieve a set of image frames from a plurality of stored image frames in the database based on the ID of the user, the information of the at least one scene and metadata associated with the set of image frames, the set of image fames including the user in the at least one scene in the AR/VR environment; generate the third person AR content view of the user by combining the set of image frames based on the metadata associated with the set of image frames; and display the third person AR content.

The information of the at least one scene may include at least one of a scene ID, a scene tag, a scene description, a time stamp associated with a scene, and location information of the at least one scene.

The metadata associated with the set of image frames may include at least one of device IDs of the plurality of participant devices, participant IDs of a plurality of participants identified in the plurality of image frames, location information and geo-location information associated with the plurality of participant devices, and privacy keys of the plurality of participants.

The privacy keys of the plurality of participants may be used to authenticate the user for uploading content to the database or accessing content from the database.

The server may be further configured to: detect the ID of the user, the information of the at least one scene, and the metadata associated with the plurality of image frames captured by the plurality of participant devices; determine a correlation between the information of the at least one scene and the metadata associated with the plurality of image frames based on the ID of the user; and retrieve the set of image frames from the database based on the ID of the user and the correlation between the information of the at least one scene and the metadata associated with the plurality of image frames.

The server may be further configured to: authenticate the received AR content generation request; based on authenticating the received AR content generation request, collect the set of image frames from the database; and combine the set of image frames based on the metadata associated with the set of image frames, to generate the third person AR content view of the user.

According to an aspect of the disclosure, a non-transitory computer readable medium stores computer readable program code or instructions which are executable by a processor to perform a method for generating Augmented Reality (AR) content. The method includes: receiving, by an AR system, a plurality of image frames of at least one scene captured by a plurality of participant devices in an AR environment or a Virtual Reality (VR) environment (AR/VR environment); storing, by the AR system, the plurality of image frames and metadata associated with the plurality of image frames, in a database; receiving, by the AR system, an AR content generation request to generate a third person AR content view of a user in the AR/VR environment, the AR content generation request including an identifier (ID) of the user and information of the at least one scene; retrieving, by the AR system, a set of image frames from a plurality of stored image frames in the database based on the ID of the user, the information of the at least one scene, and metadata associated with the set of image frames, the set of images including the user in the at least one scene in the AR/VR environment; generating, by the AR system, the third person AR content view of the user by combining the set of image frames retrieved from the database, based on the metadata associated with the set of image frames; and displaying, by the AR system, the third person AR content view.

The information of the at least one scene may include at least one of a scene ID, a scene tag, a scene description, a time stamp associated with a scene, and location information of the at least one scene.

The metadata may include at least one of device IDs of the plurality of participant devices, participant IDs of a plurality of participants identified in the plurality of image frames, location information and geo-location information associated with the plurality of participant devices, and privacy keys of the plurality of participants.

The privacy keys of the plurality of participants may be used to authenticate the user for managing content in the database.

The retrieving, by the AR system, the set of image frames from the plurality of stored image frames in the database may include: detecting, by the AR system, the ID of the user, the information of the at least one scene, and the metadata associated with the plurality of image frames captured by the plurality of participant devices; determining, by the AR system, a correlation between the information of the at least one scene and the metadata associated with the plurality of image frames based on the ID of the user; and retrieving, by the AR system, the set of image frames from the database based on the ID of the user and the correlation between the information of the at least one scene and the metadata associated with the plurality of image frames.

The generating, by the AR system, the third person AR content view of the user may include: authenticating, by the AR system, the received AR content generation request received from the user; based on authenticating the received AR content generation request, collecting, by the AR system, the set of image frames from the database; and combining, by the AR system, the set of image frames based on the metadata associated with the set of image frames to generate the third person AR content view of the user.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a block diagram of an Augmented Reality (AR)/Virtual Reality (VR) device for capturing camera feeds, according to an embodiment;

FIG. 2 is a block diagram of a server for generating AR content, according to an embodiment;

FIG. 3 is a flow chart illustrating a method for generating AR content by a server, according to an embodiment;

FIG. 4 illustrates an example procedure for generating AR content, according to an embodiment;

FIG. 5 illustrates an example process for generating AR content, according to an embodiment;

FIG. 6A is a schematic view of a Simultaneous Localization and Mapping (SLAM) engine for scene localization, according to an embodiment; embodiment;

FIG. 6B illustrates an example of camera pose estimation, according to an

FIG. 6C illustrates an example of a process for uploading camera feeds on a server, according to an embodiment;

FIG. 6D illustrates an example of Ultra-wideband (UWB) based localization information, according to an embodiment;

FIG. 7 illustrates an example of a process for estimating pose from multiple views, according to an embodiment;

FIG. 8 is a block diagram of a high-level SLAM pipeline, according to an embodiment;

FIG. 9 illustrates an example of a Time difference of arrival (TDoA) method for determining position of sensor tags, according to an embodiment;

FIG. 10 is a schematic view illustrating metadata structure and formation of the metadata, according to an embodiment;

FIG. 11 is a block diagram illustrating a process for generating AR content, according to an embodiment;

FIG. 12 illustrates an example of neural networks used to encode complex 3D environments, according to an embodiment;

FIG. 13 illustrates an example of a process for aggregating image frames captured collaboratively using pose information, according to an embodiment;

FIG. 14 illustrates an example of a process for sparse and dense reconstruction using image frames captured collaboratively, according to an embodiment; and

FIGS. 15A and 15B are flow diagrams illustrating a scenario for generating AR content, according to an embodiment.

### DETAILED DESCRIPTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits and the like, and may optionally be driven by firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Accordingly, the embodiments herein disclose a method for generating AR content using a plurality of participant devices. The method includes receiving, by an AR system, a plurality of image frames of at least one scene captured by a plurality of participant devices in an AR/Virtual Reality (VR) environment. The method includes storing, by the AR system, the plurality of image frames and corresponding metadata files in a database. The method includes receiving, by the AR system, a request from a user to generate a third person AR content view of the user in the AR/VR environment, where the AR content generation request comprises an identifier (ID) of the user and information about the at least one scene. The method also includes retrieving, by the AR system, a set of image frames from the plurality of stored image frames from the database based on the ID of the user, the information of the at least one scene and the metadata files, where the retrieved set of images includes the user in the at least one scene in the AR/VR environment. The method includes generating, by the AR system, the third person AR content view of the user by combining the set of retrieved image frames comprising the user based on the metadata files of the set of retrieved image frames, and displaying, by the AR system, the third person AR content view to the user.

Accordingly, the embodiments herein disclose the AR system for generating AR content using the plurality of participant devices. The AR system includes the plurality of participant devices, an AR/VR device and a server. The AR/VR device includes a memory, a processor coupled to the memory, a communicator coupled to the memory and the processor, and an image management controller coupled to the memory, the processor and the communicator. The image management controller configured to receive the plurality of image frames of at least one scene captured by a plurality of participant devices in an AR/VR environment, and store the plurality of image frames and corresponding metadata files in the database. The server is configured to receive the request from the user to generate the third person AR content view of the user in the AR/VR environment, where the AR content generation request includes the ID of the user and information about the at least one scene. The server is configured to retrieve the set of image frames from the plurality of stored image frames from the database based on the ID of the user, the information of the at least one scene and the metadata files, where the retrieved set of images includes the user in the at least one scene in the AR/VR environment. The server is configured to generate the third person AR content view of the user by combining the set of retrieved image frames including the user based on the metadata files of the set of retrieved image frames, and display the third person AR content view to the user.

Example embodiments of the present disclosure may create the third person view of the user using camera feeds from one or more participants using the participant devices for example an AR/VR device. In an embodiment, a in-built SLAM engine may be used for scene localization, which aids in scene stitching, view creation, scene collage, etc. Further, the SLAM engine may provide localization information of the scene in a 3D space. In an embodiment, an Ultra-wideband (UWB) sensor may be used for scene security and personalization. In an embodiment, the method includes collaborative capture of the image frames, accurate saving of metadata information for future use, Artificial Intelligence techniques, cloud-based analytics and data handling combined with computer vision, which enables the user to have seamless connected experience.

Hereinafter, embodiments of the present disclosure will be described in detail with reference to the accompanying drawings, where similar reference characters denote corresponding features consistently throughout.

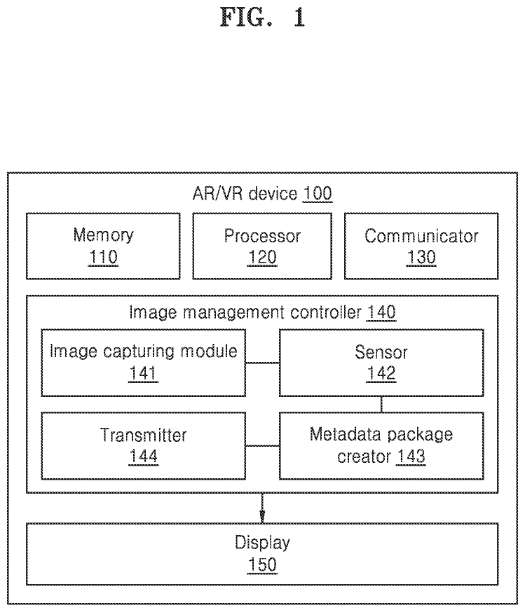

FIG. 1 is a block diagram of an Augmented Reality (AR)/Virtual Reality (VR) device 100 for capturing camera feeds, according to an embodiment 100. Referring to FIG. 1, the AR/VR device 100 includes but not limited to a wearable device, an Internet of Things (IoT) device, a virtual reality device, a foldable device, a flexible device, a display device and an immersive system.

In an embodiment, the AR/VR device 100 includes a memory 110, a processor 120, a communicator 130, an image management controller 140, and a display 150.

The memory 110 is configured to store feeds captured by the participant devices. The memory 110 includes non-volatile storage elements. Examples of such non-volatile storage elements include magnetic hard discs, optical discs, floppy discs, flash memories, or forms of electrically programmable memories (EPROM) or electrically erasable and programmable (EEPROM) memories. In addition, the memory 110 is considered as a non-transitory storage medium. The term “non-transitory” indicates that the storage medium is not embodied in a carrier wave or a propagated signal. However, the term “non-transitory” is not interpreted that the memory 110 is non-movable. In some examples, the memory 110 is configured to store larger amounts of information. In certain examples, a non-transitory storage medium stores data that changes over time (e.g., in Random Access Memory (RAM) or cache). The memory 110 may store at least one instruction executable by the processor 120.

The processor 120 includes one or a plurality of processors. The one or the plurality of processors is a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor 120 includes multiple cores and is configured to execute the instructions stored in the memory 110.

In an embodiment, the communicator 130 includes an electronic circuit specific to a standard that enables wired or wireless communication. The communicator 130 is configured to communicate internally between internal hardware components such as for example but not limited to the memory 110, the processor 120, the image management controller 140 and the display 150 of the AR/VR device 100 and with external devices via one or more networks.

In an embodiment, the image management controller 140 includes an image capturing module 141, a UWB sensor 142, a metadata package creator 143 and a transmitter 144.

In an embodiment, the image capturing module 141 is configured to capture camera feeds and/or image frames from one or more participant devices. Examples of the participant devices include but not limited to a wearable head mounted display device, the virtual reality device, and the like.

In an embodiment, the UWB sensor 142 for example an Ultra-Wideband (UWB) sensor is configured to determine or identify location information of the participant devices.

In an embodiment, the metadata package creator 143 is configured to receive the camera feeds and/or image frames captured by the participant devices and the location information of the participant devices identified by the UWB sensor 142. The metadata package creator 143 creates metadata by combining the camera feeds and/or image frames captured by the participant devices and the location information of the participant devices identified by the UWB sensor 142.

In an embodiment, the transmitter 144 is configured to receive the metadata created by the metadata package creator 143 and transmit to a server 200.

The image management controller 140 is implemented by processing circuitry such as logic gates, integrated circuits, microprocessors, microcontrollers, memory circuits, passive electronic components, active electronic components, optical components, hardwired circuits, or the like, and is optionally driven by a firmware. The circuits are embodied in one or more semiconductor chips, or on substrate supports such as printed circuit boards and the like.

At least one of the plurality of modules/components of the image management controller 140 is implemented through an AI model. A function associated with the AI model is performed through the memory 110 and the processor 120. The one or a plurality of processors 120 controls the processing of the input data in accordance with a predefined operating rule or the AI model stored in the non-volatile memory and the volatile memory. The predefined operating rule or the AI model is provided through training or learning.

Here, being provided through learning means that, by applying a learning process to a plurality of learning data, a predefined operating rule or AI model of a desired characteristic is made. The learning is performed in a device itself in which AI according to an embodiment is performed, and/or is implemented through a separate server/system.

The AI model consists of a plurality of neural network layers. Each layer has a plurality of weight values and performs a layer operation through calculation of a previous layer and an operation of a plurality of weights. Examples of neural networks include, but are not limited to, convolutional neural network (CNN), deep neural network (DNN), recurrent neural network (RNN), restricted Boltzmann Machine (RBM), deep belief network (DBN), bidirectional recurrent deep neural network (BRDNN), generative adversarial networks (GAN), and deep Q-networks.

The learning process is a method for training a predetermined target device (for example, a robot) using a plurality of learning data to cause, allow, or control the target device to make a determination or prediction. Examples of learning processes include, but are not limited to, supervised learning, unsupervised learning, semi-supervised learning, or reinforcement learning.

In an embodiment, the display 150 is configured to provide a set of image frames having correlated parameters retrieved from the server. The display 150 is implemented using touch sensitive technology and comprises one of liquid crystal display (LCD), light emitting diode (LED), etc.

Although FIG. 1 show the hardware elements of the AR/VR device 100 but it is to be understood that other embodiments are not limited thereon. In other embodiments, the AR/VR device 100 include less or more number of elements. Further, the labels or names of the elements are used only for illustrative purpose and does not limit the scope of the disclosure. One or more components are combined together to perform same or substantially similar function.

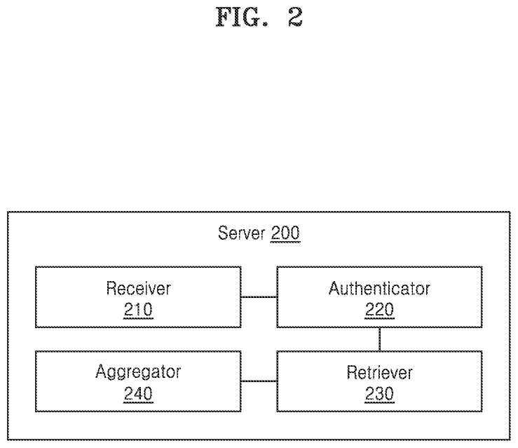

FIG. 2 is a block diagram of a server 200 for generating AR content, according to an embodiment.

Referring to FIG. 2, the server 200 includes a receiver 210, an authenticator 220, a retriever 230, and an aggregator 240.

In an embodiment, the receiver 210 is configured to receive and store image frames captured by the image capturing module 141 of the image management controller 140, and an identifier (ID) of the user. The image frames include a plurality of parameters associated with each image frame. The plurality of parameters associated with each image frame includes scene elements for example, players in the image frame, actions for example, playing of the scene elements in the image frame, and location information, for example playground of the scene elements in the image frame.

The receiver 210 is also configured to receive a request, for example an AR content generation request from one of the participant devices, when the user needs to construct the third person view in an AR experience or create the AR content using the third person view. The AR content generation request includes the ID of the user and scene information as metadata. The scene information includes a scene ID, a scene tag, a scene description, a time stamp associated with a scene, an authentication key of the user, location information of the user and a geo-location information associated with the scene.

In an embodiment, the authenticator 220 is configured to determine an identity of the user upon receiving the AR content generation request including the metadata. The identity of the user is determined by receiving the authentication key of the user, and determining a match between the authentication key of the user and the ID of the user stored in the server. The authenticator 220 authenticates the identity of the user when the authentication key of the user and the ID of the user stored in the server matches.

In an embodiment, the retriever 230 is configured to determine the plurality of parameters associated with each image frame of the plurality of image frames, and determine a correlation between the plurality of parameters of the plurality of image frames in response to the identity of the user. The set of image frames having correlated parameters are stored in a database. The set of image frames having correlated parameters are retrieved from the database by the retriever 230.

In an embodiment, the aggregator 240 is configured to receive the retrieved set of image frames having correlated parameters from the retriever 230 and aggregates the retrieved set of image frames to create the AR content using the third person view, and reconstruct a 3D scene to create a memory album.

Although FIG. 2 show the hardware elements of the server 200 but it is to be understood that other embodiments are not limited thereon. In other embodiments, the server 200 includes less or more number of elements. Further, the labels or names of the elements are used only for illustrative purpose and does not limit the scope of the disclosure. One or more components are combined together to perform same or substantially similar function.

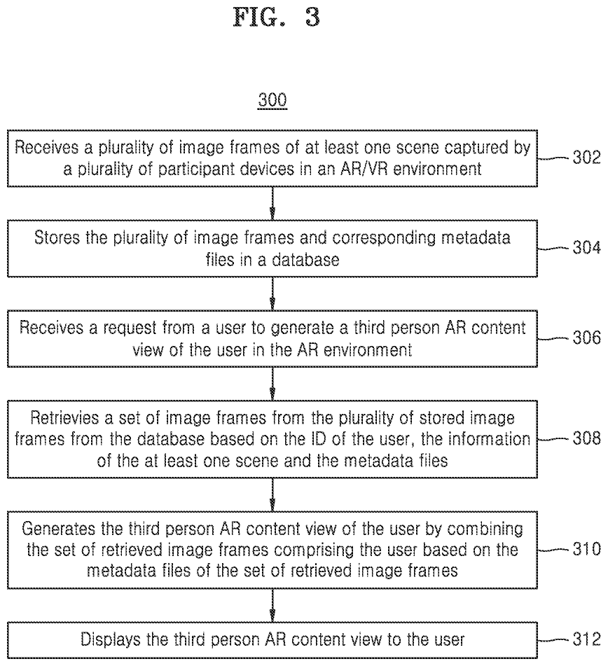

FIG. 3 is a flow chart 300 illustrating a method for generating AR content by a server, according to an embodiment.

Referring to FIG. 3, at operation 302, the method includes the AR/VR device 100 receiving the image frames of at least one scene captured by the participant devices in an AR/VR environment. For example, in the AR/VR device 100 as illustrated in FIG. 1, the image management controller 140 is configured to receive the image frames of at least one scene captured by the participant devices in the AR/VR environment.

At operation 304, the method includes the AR/VR device 100 storing the plurality of image frames and corresponding metadata files in the database. For example, in the AR/VR device 100 as illustrated in FIG. 1, the image management controller 140 is configured to store the plurality of image frames and corresponding metadata files in the database.

At operation 306, the method includes the server 200 receiving the request from the user to generate the third person AR content view of the user in the AR/VR environment. The AR content generation request includes an ID of the user and information about the at least one scene.

At operation 308, the method includes the server 200 retrieving the set of image frames from the plurality of stored image frames from the database based on the ID of the user, the information of the at least one scene and the metadata files. The retrieved set of images includes the user in the at least one scene in the AR/VR environment.

At operation 310, the method includes the server 200 generating the third person AR content view of the user by combining the set of retrieved image frames including the user based on the metadata files of the set of retrieved image frames.

At operation 312, the method includes the server 200 displaying the third person AR content view to the user.

The various actions, acts, blocks, steps, or the like in the method may be performed in the order presented, in a different order or simultaneously. Further, in some embodiments, some of the actions, acts, blocks, steps, or the like may be omitted, added, modified, skipped, or the like without departing from the scope of the disclosure.

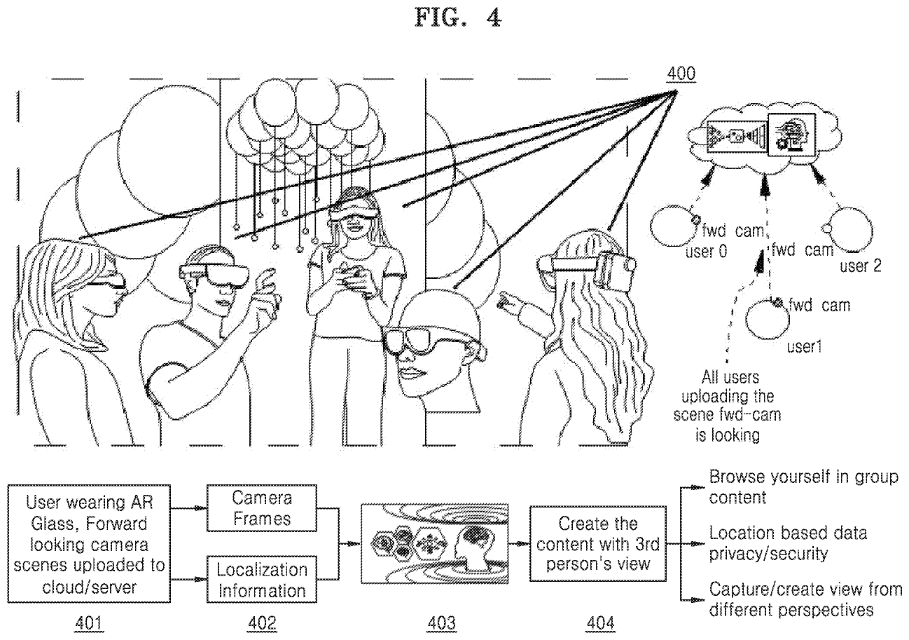

FIG. 4 illustrates an example procedure 400 for generating AR content, according to an embodiment.

Referring to FIG. 4, at operation 401, the user wearing the participating device for example an AR glass captures the image frames of the at least one scene. The captured image frames of the at least one scene is transmitted to the server 200.

At operation 402, the server 200 receives the image frames of the at least one scene captured by the participant devices in the AR/VR environment along with the location information of the at least one scene. The server 200 stores the image frames and the location information of the at least one scene in the database.

At operation 403, the server 200 receives the request to generate the third person AR content view of the user from the participant device. The AR content generation request includes the ID of the user and information about the at least one scene. The information of the at least one scene includes but not limited to the scene ID, the scene tag, the scene description, the time stamp associated with the scene, and the location information of the at least one scene.

At operation 404, the server 200 retrieves the set of image frames from the plurality of stored image frames from the database based on the ID of the user, the information of the at least one scene and the metadata files. The retrieved set of images includes the user in the at least one scene in the AR/VR environment. Further, the server 200 generates the third person AR content view of the user by combining the set of retrieved image frames including the user based on the metadata files of the set of retrieved image frames.

The third person AR content view of the user is used to browse for the user in a group content, ensure location-based data privacy security, and capture a create view from different perspectives in efficient manner.

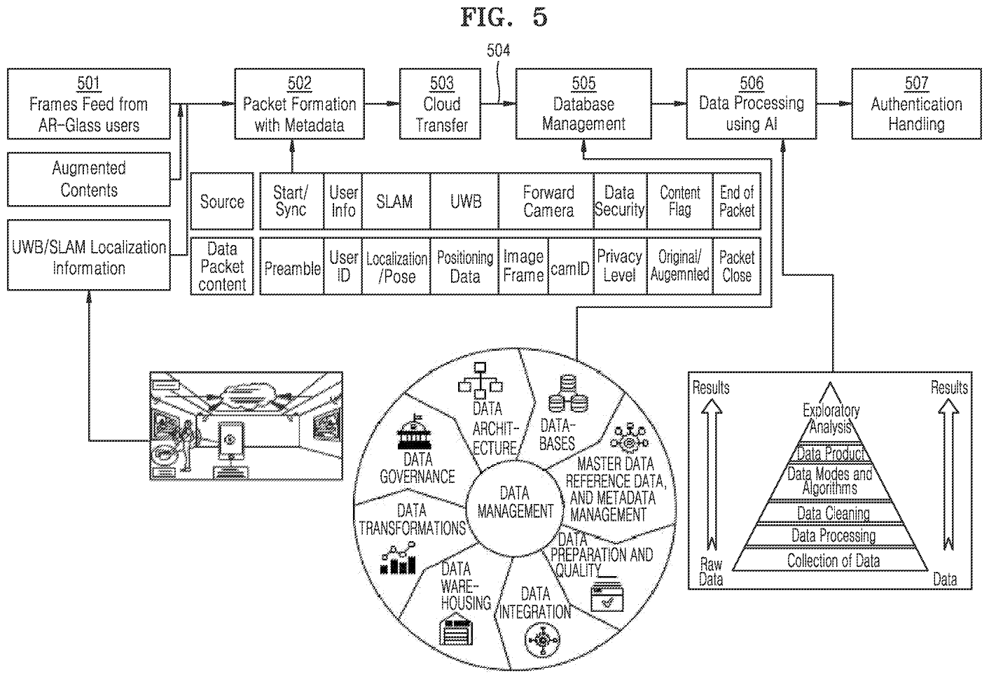

FIG. 5 illustrates an example process for generating AR content, according to an embodiment.

Referring to FIG. 5, the method enables the user to create/capture the third person view of the scene along with AR object interaction. At operation 501, the image frames feed from the participant devices, the augmented contents and the localization information are collected by the AR/VR device 100.

At operation 502, the AR/VR device 100 forms a packet with the corresponding metadata files. The metadata files include but not limited to data packet content, IDs of the participant devices, IDs of the users/participants identified in the image frames, the location information and geo-location information associated with the participant devices.

At operation 503, the AR/VR device 100 transmits the packet formed with the corresponding metadata files along with the image frames feed from the participant devices and the augmented contents to the server 200 via a cloud transfer.

At operation 504, the server 200 receives the packet formed with the corresponding metadata files along with the image frames feed from the participant devices and the augmented contents from the AR/VR device 100.

At operation 505, the server 200 performs data management which include but not limited to data architecture, database formation, master data, reference data and metadata management, data preparation and quality management, data integration, data warehousing, data transformations and data governance.

At operation 506, the server 200 performs data processing using the AI model. The AI model processes the data to identify the image frames including the user and provide the user with his personalized metadata.

At operation 507, the server 200 allows the user to access his moments seamlessly and create 3D content, with security and personalization addressed.

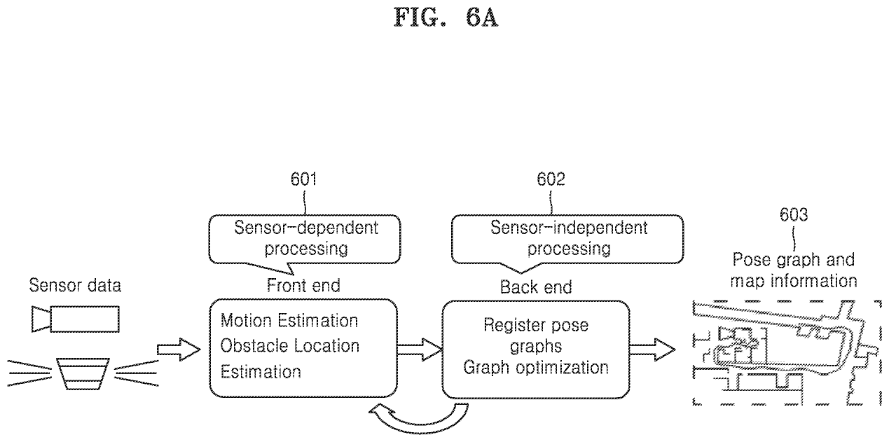

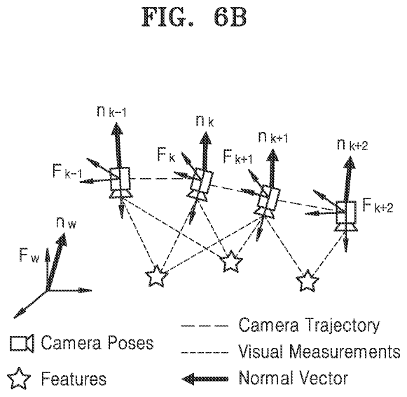

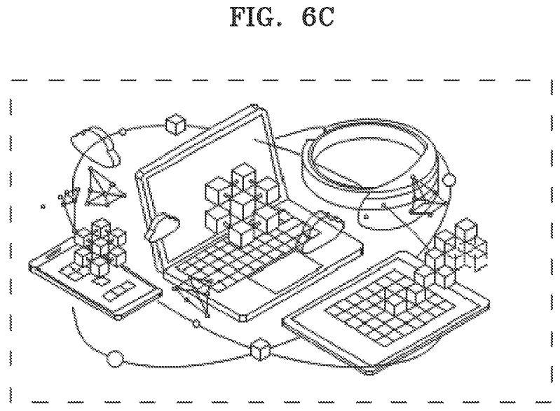

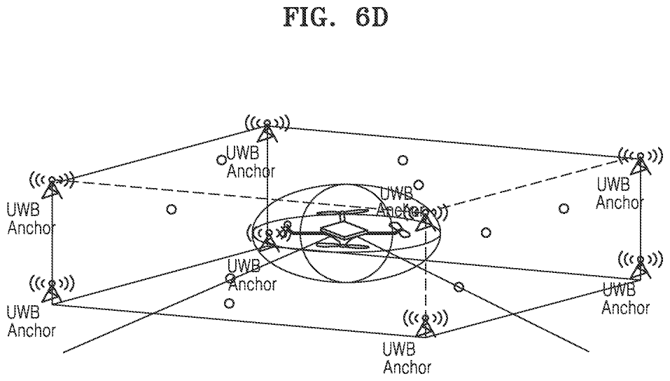

FIG. 6A is a schematic view of a Simultaneous Localization and Mapping (SLAM) engine for scene localization, according to an embodiment.

Referring to FIG. 6A, the UWB sensor 142 is configured to collect the data captured by the participant devices.

At operation 601, the SLAM engine is configured to perform sensor-dependent processing of the data captured by the participant devices. The UWB sensor 142 is configured to perform motion estimation and obstacle location estimation from the processed data.

At operation 602, the SLAM engine is configured to perform sensor-independent processing of the data captured by the participant devices. The UWB sensor 142 is configured to generate pose graphs and perform optimization of the pose graphs.

At operation 603, the pose graphs and information associated with the pose graphs are stored in the database.

FIG. 6B illustrates an example of camera pose estimation, according to an embodiment.

Referring to FIG. 6B, the data captured by the participant devices include but not limited to camera poses of the participant devices, features of the participant devices, a camera trajectory, visual measurements and a normal vector. The data captured by the participant devices is used for camera pose estimation.

FIG. 6C illustrates an example of a process for uploading camera feeds on a server, according to an embodiment 200.

Referring to FIG. 6C, the participant devices capture the image frames of the scene in the AR/VR environment, and uploads the captured image frames of the scene in the server 200.

FIG. 6D illustrates an example of Ultra-wideband (UWB) based localization information, according to an embodiment.

Referring to FIG. 6D, the SLAM engine is used for scene localization and aids for scene stitching, novel view creation, scene collage, etc. The SLAM engine provides localization information of the scene in a 3D space. Further, using SLAM engine, the AI model generates graph of the user and surrounding AR/VR environment. The UWB based localization information is used for scene security and personalization.

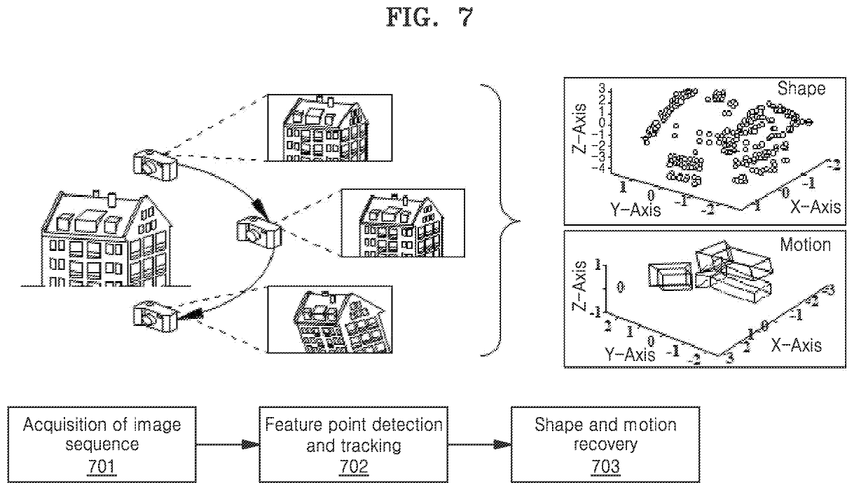

FIG. 7 illustrates an example of a process for estimating pose from multiple views, according to an embodiment.

Referring to FIG. 7, at operation 701, the AR/VR device 100 acquires a sequence of image frames from the participant devices.

At operation 702, the AR/VR device 100 performs feature point detection and tracking from the acquired sequence of image frames.

At operation 703, the AR/VR device 100 performs shape and motion recovery after performing feature point detection and tracking from the acquired sequence of image frames.

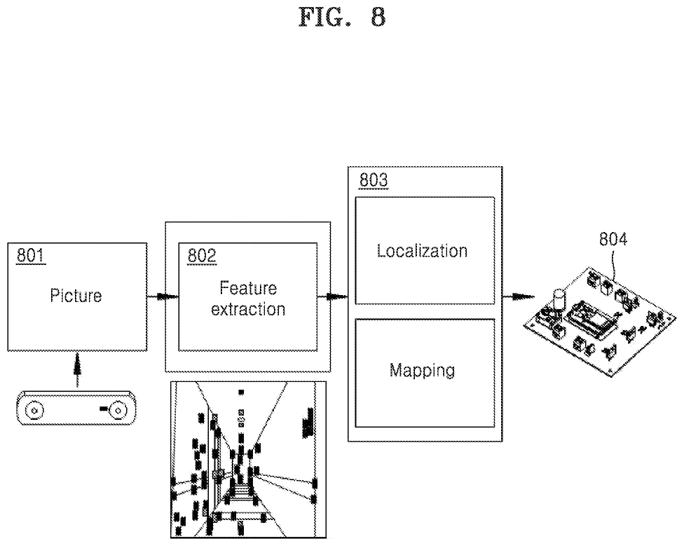

FIG. 8 is a block diagram of a high-level SLAM pipeline, according to an embodiment.

Referring to FIG. 8, at operation 801, the AR/VR device 100 stores the image frames captured by the participant devices.

At operation 802, the AR/VR device 100 extracts the features of the stored image frames.

At operation 803, the AR/VR device 100 determines location information of the participant devices from the stored image frames and generates environment maps based on the stored image frames.

At operation 804, a structure is generated using the stored image frames and respective camera positions of the participant devices in response to determining the location information of the participant devices.

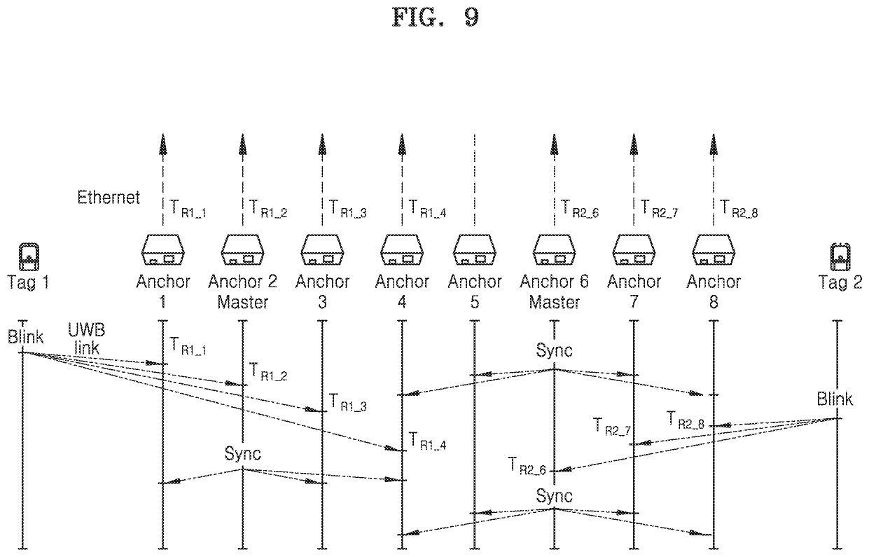

FIG. 9 illustrates an example of a Time difference of arrival (TDoA) method for determining position of sensor tags, according to an embodiment 142.

Referring to FIG. 9, in order for the TDoA method to work effectively, anchor sensors of the UWB sensor 142 has to be accurately synchronized. With TDoA method, sensor tags transmit blink messages in regular intervals or refresh rates. The blink messages are processed by all of the anchor sensors within a communication range. In order to determine the position of the sensor tags, a Real-time Locating System (RTLS) server considers only timestamps coming from at least four anchors with a same clock base. UWB sensor tag is associated with each unique user. Based on time difference, sensor tag pose is determined with respect to the position of the anchor sensors to determine the location information of the participant device in a camera view.

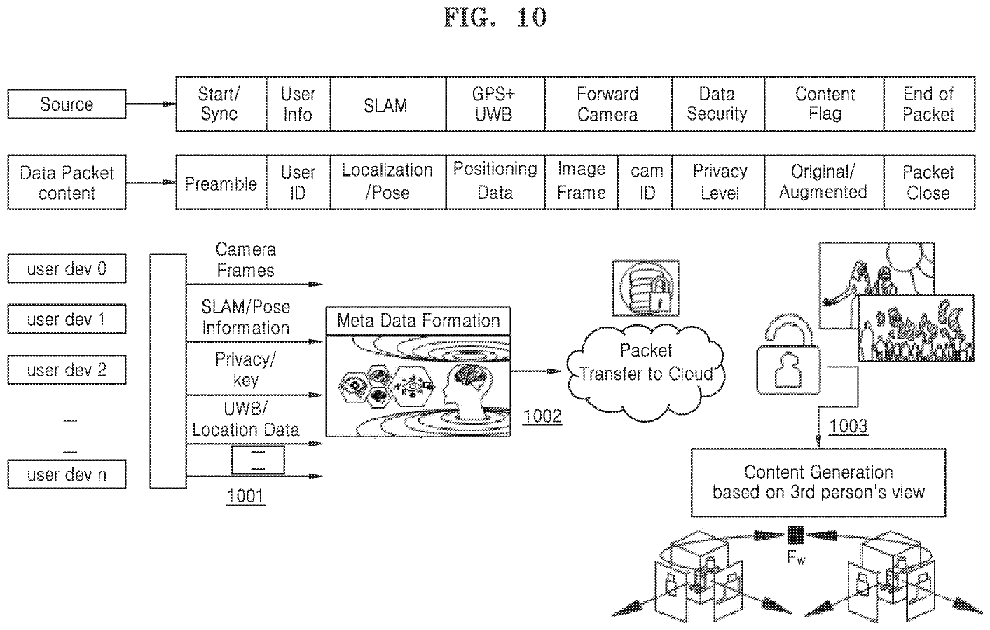

FIG. 10 is a schematic view illustrating metadata structure and formation of the metadata, according to an embodiment.

Referring to FIG. 10, at operation 1001, the participant/user devices (0-n) capture the image frames and collects the metadata files of the scene in the AR/VR environment. The metadata files of the scene include but not limited to pose information, a privacy key and UWB location data. The image frames and the corresponding metadata files are used for formation of the metadata structure. Table 1 illustrates the metadata structure and formation.

TABLE 1

| | Metadata packet | |
|---|---|---|
| Metadata Source | content | Explanation |
| Start/Sync | Preamble | A signal to synchronize |
| | | transmission/start between the user AR |
| | | Glass and the cloud/server |
| User Info | User ID | A unique identification code assigned |
| | | to the user that is used for mapping |
| | | metadata packet to concerned |
| | | user/user's content |
| SLAM | Localization/Pose | An estimated camera poses in user |
| | | environment that is used for scene |
| | | stitching, content creation and |
| | | localizing user in a view/local visual |
| | | map |
| UWB | Positioning Data | Exact location coordinates of user in |
| | | the environment, where Global |
| | | Positioning System (GPS) accuracy is |
| | | not sufficient to differentiate nearby |
| | | users |
| Forward Camera | Image Frame | Camera frames captured by the AR |
| | | Glass, corresponding to the given user |
| | | ID |
| | Camera ID | Camera frames captured from the |
| | | particular camera ID of user's AR |
| | | Glass, as the device is equipped with |
| | | multiple cameras |
| Data Security | Privacy Level | User's privacy key to authenticate user |
| | | to upload/access content to/from the |
| | | cloud. Different privacy levels (e.g., |
| | | delete content from the cloud) are |
| | | maintained for restricting user's |
| | | authorization. |
| Content Flag | Original/Augmented | Original - Upload only those camera |
| | | frames that have no augmented content |
| | | in it. Real scene with user surroundings |
| | | captured by forward looking cameras. |
| | | Augmented - Upload both camera |
| | | frames: with Augmented objects and |
| | | without any Augmented object. |
| | | Augmented objects are saved with |
| | | sufficient information so that it is |
| | | recreated nicely. |

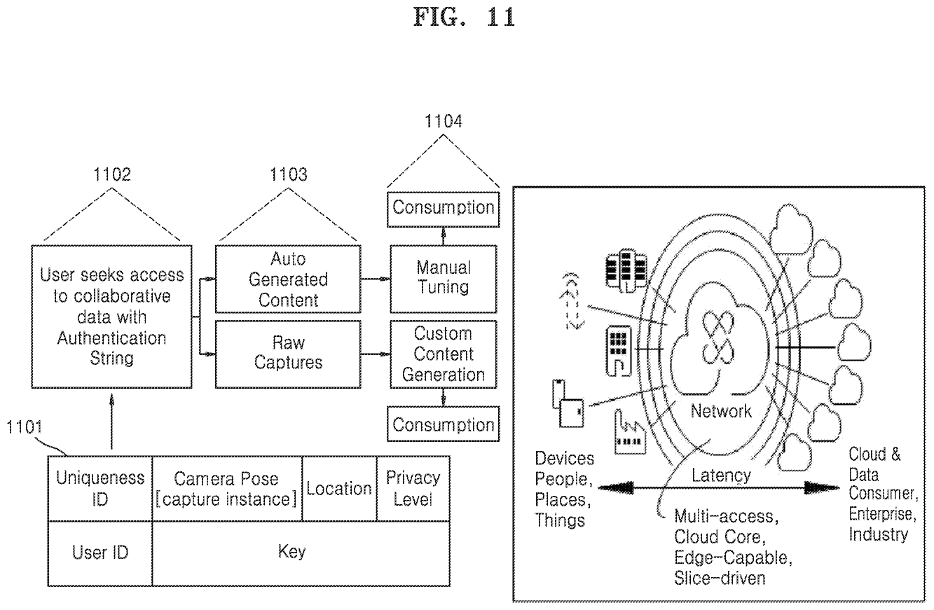

FIG. 11 is a block diagram illustrating a process for generating AR content, according to an embodiment.

Referring to FIG. 11, at operation 1101, the information of the scene including the scene ID, the scene tag, the scene description, the time stamp associated with the scene, and the location information of the one scene are received by the server 200.

At operation 1102, the user seeks access to collaborative data with an authentication string for example the authentication key by sending the request to generate the third person AR content view of the user in the AR/VR environment to the server 200. The AR content generation request includes the ID of the user and the information about the scene.

At operation 1103, the server 200 auto generates content using the ID of the user and the information about the scene.

At operation 1104, the server 200 receives the image frames captured by the participant device and performs custom content generation using the received image frames.

The third person AR content is generated by synthesizing different views of complex scenes by optimizing an underlying continuous volumetric scene function using a sparse set of input views.

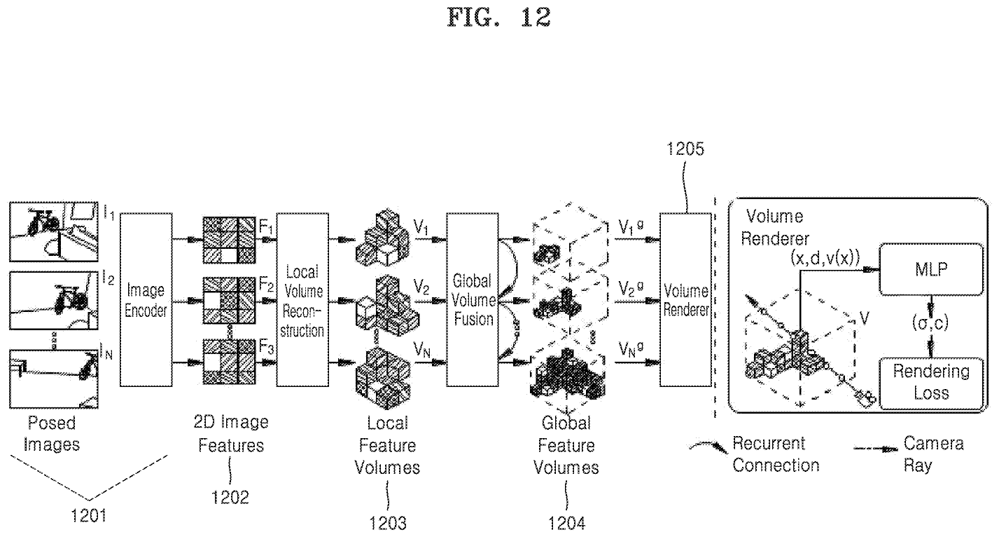

FIG. 12 illustrates an example of neural networks used to encode complex 3D environments, according to an embodiment.

Referring to FIG. 12, neural networks are used to encode the complex 3D environments that are rendered photo realistically from different viewpoints.

At operation 1201, the image frames are input into an image encoder.

At operation 1202, Two-Dimensional (2D) image features are determined from the input image frames.

At operation 1203, local volume reconstruction is carried out to determine local feature volumes from the 2D image features.

At operation 1204, global volume fusion is carried out to obtain global feature volumes from the 2D image features.

At operation 1205, the local feature volumes and the global feature volumes are shared with a volume renderer and determines rendering loss from the local feature volumes and the global feature volumes to encode complex 3D environments.

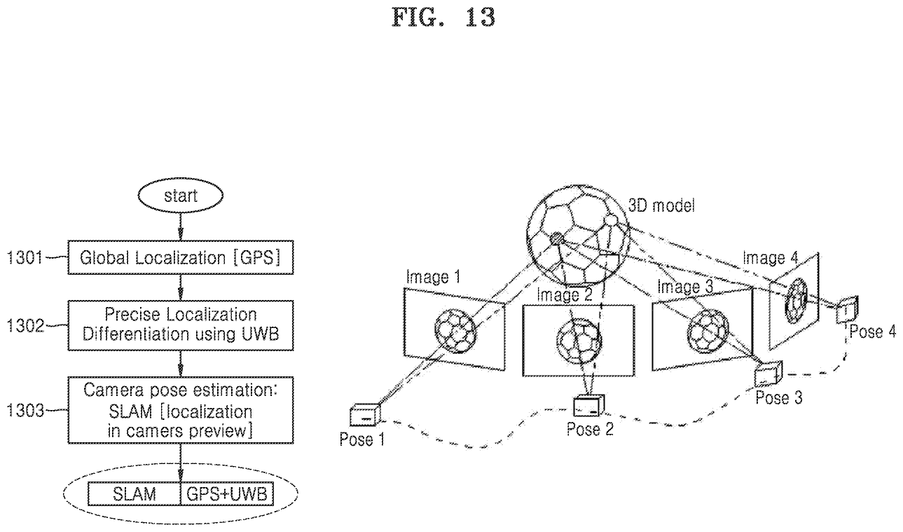

FIG. 13 illustrates an example of a process for aggregating image frames captured collaboratively using pose information, according to an embodiment.

Referring to FIG. 13, Pose1, Pose2, Pose3, Pose4 are camera positions estimated using the SLAM engine (user location in the camera preview). The GPS and the UWB carries location information in a map used as metadata for location-based security.

Considering a scenario, where a user A, a user B and a user C are in a same building, the GPS location is determined 1301 to be the same for the user A, the user B and the user C.

When the user A, the user B and the user C are in different locations of the same building, the locations of the user A, the user B and the user C are determined 1302 and made distinct using UWB based localization.

When the user A, the user B and the user C are standing together very closely, even then the locations of the user A, the user B and the user C are determined 1303 and made distinct in the camera preview using SLAM based camera pose estimation which is eventually used to stitch the image frames for content creation.

When a user D is in different location in same floor and same building but not attended the event with the user A, the user B and the user C, although the GPS location is determined to be the same as for the user A, the user B and the user C, the user D cannot access the views seen directly but the user D gets access from the user A, the user B or the user C. As camera is being tracked, dynamic user locations are considered for stitching image frames captured collaboratively using the pose information.

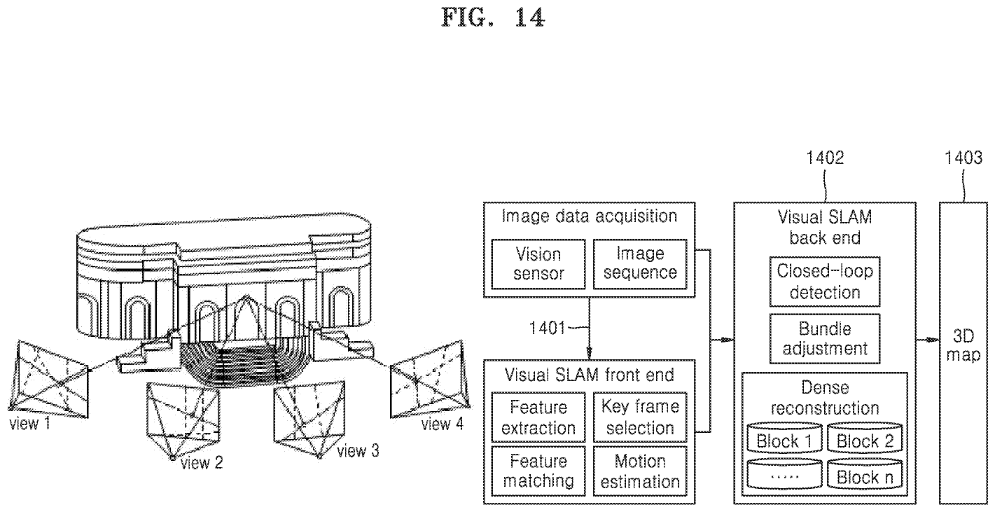

FIG. 14 illustrates an example of a process for sparse and dense reconstruction using image frames captured collaboratively, according to an embodiment.

Referring to FIG. 14, at operation 1401, the sequence of image frames is acquired from the participant devices along with the ID of the user, the information of the scene and the metadata files. A visual SLAM front-end generates preliminary camera poses.

At operation 1402, a visual SLAM back-end performs closed-loop detection and bundle adjustment for the sequence of image frames acquired from the participant devices which is in turn used for dense reconstruction.

At operation 1403, a 3D structure is reconstructed using different views of the image frames (multi view geometry). The image frames i.e., the views captured using multiple users by the participant devices, the poses of each frame generated by the SLAM engine and the calibrated camera parameters are used for reconstructing the 3D structure.

The 3D structure builds map of the user and the user's surrounding environment, enabling the users to experience and reimagine the memories. The 3D structure allows the user to create view from different perspectives and generate the 3D content, and allows the user to review his interaction with the AR object and help to recollect the discussions that took place in the event.

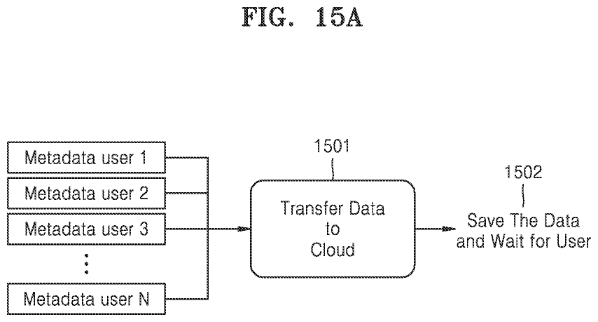

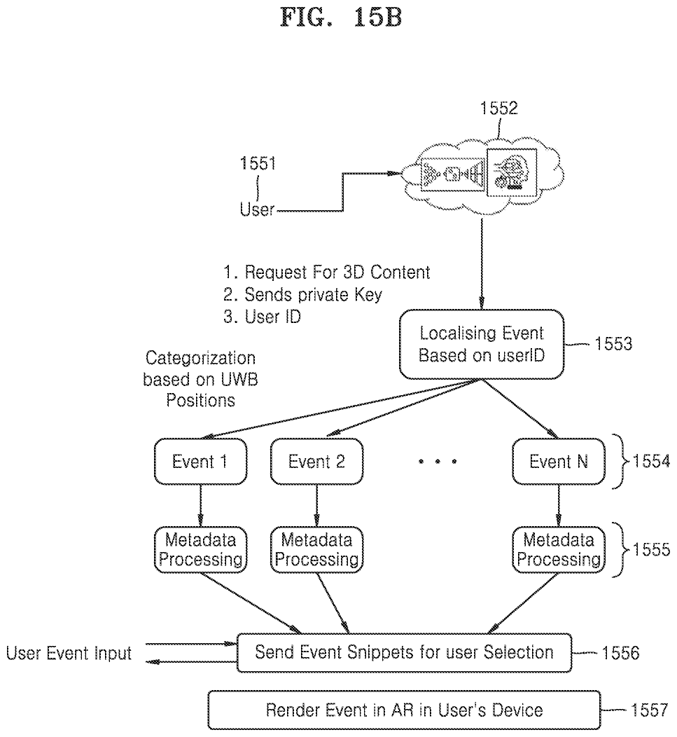

FIGS. 15A and 15B are flow diagrams illustrating a scenario for generating AR content, according to an embodiment.

Referring to FIG. 15A, at operation 1501, the image frames of the scene captured by the participant devices in the AR/VR environment are transferred to the server 200 along with the metadata files associated with the image frames of the scene.

At operation 1502, the server 200 stores the image frames of the scene captured by the participant devices in the AR/VR environment along with the corresponding metadata files in the database.

Referring to FIG. 15B, considering a scenario where two parallel events are happening, one event where the user is cutting cake and another event where some of his guests are planning to do something different instead of all usual birthday events and plan on to recreating the scene in an album. Since the user was busy with cake cutting, he missed being a part of his guest's plans and later on got to know from the videos captured by other guests. The method recreates the events using the metadata of all the image frames when the user wanted to re-experience the same.

At operation 1551, the user sends a request for recreation of the event to the server 200, after providing the authentication key, user ID and event information such as for example date and time of the event.

At operation 1552, the server 200 receives the request, authenticates the user and localizes the event using the user ID to find all the events where user is present.

At operation 1553, the server 200 starts processing all the metadata around the given time, localizes the event and keeps the image frames in different event buckets using the localization UWB information.

At operation 1554, after the localization is complete, the server 200 chooses arbitrary number of frames to recreate a sub-event.

At operation 1555, the server 200 shares event snippets to the user.

At operation 1556, upon receiving the event snippets, the user chooses a required event and sends the request to the server 200 to re-create the selected event.

At operation 1557, upon receiving the user's chosen event, the server 200 re-creates the scene using all the frames in the event bucket and renders the event in the AR/VR environment.

According to an embodiment, the user may access the moments seamlessly anywhere in groups, workshop, celebrations, special occasions, etc. The third person view of the scene along with the recorded AR object interaction are used for training, fun, moment sharing and personalization. The method makes connected components, crowd sourcing, analytics and image vision together feasible.

According to an embodiment, the image frames and the metadata may be used to provide recommendations and insights for usage of the captured image frames for creative content creation. Each of the captured image frames are scored as per the usability for content creation and 3D scene reconstruction. The generated insights and recommendations help the user to create more meaningful and realistic content.

The foregoing description of the example embodiments will so fully reveal the general nature of the embodiments herein that others can, by applying current knowledge, readily modify and or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of the example embodiments, those skilled in the art will recognize that the embodiments herein can be practiced with modification within the scope of the embodiments as claimed by the appended claims and their equivalents. Also, it is intended that such modifications are not to be interpreted independently from the technical idea or prospect of the disclosure.

What is claimed is:

1. A method for generating Augmented Reality (AR) content, comprising:
receiving, by an AR system, a plurality of image frames of at least one scene captured by a plurality of participant devices in an AR environment or a Virtual Reality (VR) environment (AR/VR environment);
storing, by the AR system, the plurality of image frames and metadata associated with the plurality of image frames, in a database;
receiving, by the AR system, an AR content generation request to generate a third person AR content view of a user in the AR/VR environment, the AR content generation request comprising an identifier (ID) of the user and information of the at least one scene;
retrieving, by the AR system, a set of image frames from a plurality of stored image frames in the database based on the ID of the user, the information of the at least one scene, and metadata associated with the set of image frames, the set of images comprising the user in the at least one scene in the AR/VR environment;
generating, by the AR system, the third person AR content view of the user by combining the set of image frames retrieved from the database, based on the metadata associated with the set of image frames; and
displaying, by the AR system, the third person AR content view.

2. The method of claim 1, wherein the information of the at least one scene comprises at least one of a scene ID, a scene tag, a scene description, a time stamp associated with a scene, and location information of the at least one scene.

3. The method of claim 1, wherein the metadata comprise at least one of device IDs of the plurality of participant devices, participant IDs of a plurality of participants identified in the plurality of image frames, location information and geo-location information associated with the plurality of participant devices, and privacy keys of the plurality of participants.

4. The method of claim 3, wherein the privacy keys of the plurality of participants are used to authenticate the user for uploading content to the database or accessing content from the database.

5. The method of claim 1, wherein the retrieving, by the AR system, the set of image frames from the plurality of stored image frames in the database comprises:
detecting, by the AR system, the ID of the user, the information of the at least one scene, and the metadata associated with the plurality of image frames captured by the plurality of participant devices;
determining, by the AR system, a correlation between the information of the at least one scene and the metadata associated with the plurality of image frames based on the ID of the user; and
retrieving, by the AR system, the set of image frames from the database based on the ID of the user and the correlation between the information of the at least one scene and the metadata associated with the plurality of image frames.

6. The method of claim 1, wherein the generating, by the AR system, the third person AR content view of the user comprises:
authenticating, by the AR system, the received AR content generation request received from the user;
based on authenticating the received AR content generation request, collecting, by the AR system, the set of image frames from the database; and
combining, by the AR system, the set of image frames based on the metadata associated with the set of image frames to generate the third person AR content view of the user.

7. A system for generating Augmented Reality (AR) content, comprising:
a plurality of participant devices;
an AR device or Virtual Reality (VR) device (AR/VR device); and
a server,
wherein the AR/VR device comprises:
a communicator;
an image management controller;
a memory storing at least one instruction; and
at least one processor operatively connected to the communicator, the image management controller, and the memory, the at least one processor configured to execute the at least one instruction to:
receive a plurality of image frames of at least one scene captured by the plurality of participant devices in an AR/VR environment, and
store the plurality of image frames and metadata associated with the plurality of image frames in a database,
wherein the server is configured to:
receive an AR content generation request to generate a third person AR content view of a user in the AR/VR environment, the AR content generation request comprising an identifier (ID) of the user and information of the at least one scene,
retrieve a set of image frames from a plurality of stored image frames in the database based on the ID of the user, the information of the at least one scene and metadata associated with the set of image frames, the set of image fames comprising the user in the at least one scene in the AR/VR environment;
generate the third person AR content view of the user by combining the set of image frames based on the metadata associated with the set of image frames; and
display the third person AR content view.

8. The system of claim 7, wherein the information of the at least one scene comprises at least one of a scene ID, a scene tag, a scene description, a time stamp associated with a scene, and location information of the at least one scene.

9. The system of claim 7, wherein the metadata associated with the set of image frames comprise at least one of device IDs of the plurality of participant devices, participant IDs of a plurality of participants identified in the plurality of image frames, location information and geo-location information associated with the plurality of participant devices, and privacy keys of the plurality of participants.

10. The system of claim 9, wherein the privacy keys of the plurality of participants are used to authenticate the user for uploading content to the database or accessing content from the database.

11. The system of claim 7, wherein the server is further configured to:
detect the ID of the user, the information of the at least one scene, and the metadata associated with the plurality of image frames captured by the plurality of participant devices;
determine a correlation between the information of the at least one scene and the metadata associated with the plurality of image frames based on the ID of the user; and
retrieve the set of image frames from the database based on the ID of the user and the correlation between the information of the at least one scene and the metadata associated with the plurality of image frames.

12. The system of claim 7, wherein the server is further configured to:
authenticate the received AR content generation request;
based on authenticating the received AR content generation request, collect the set of image frames from the database; and
combine the set of image frames based on the metadata associated with the set of image frames, to generate the third person AR content view of the user.

13. A non-transitory computer readable medium for storing computer readable program code or instructions which are executable by a processor to perform a method for generating Augmented Reality (AR) content, the method comprising:
receiving, by an AR system, a plurality of image frames of at least one scene captured by a plurality of participant devices in an AR environment or a Virtual Reality (VR) environment (AR/VR environment);
storing, by the AR system, the plurality of image frames and metadata associated with the plurality of image frames, in a database;
receiving, by the AR system, an AR content generation request to generate a third person AR content view of a user in the AR/VR environment, the AR content generation request comprising an identifier (ID) of the user and information of the at least one scene;
retrieving, by the AR system, a set of image frames from a plurality of stored image frames in the database based on the ID of the user, the information of the at least one scene, and metadata associated with the set of image frames, the set of images comprising the user in the at least one scene in the AR/VR environment;
generating, by the AR system, the third person AR content view of the user by combining the set of image frames retrieved from the database, based on the metadata associated with the set of image frames; and
displaying, by the AR system, the third person AR content view.

14. The non-transitory computer readable medium of claim 13, wherein the information of the at least one scene comprises at least one of a scene ID, a scene tag, a scene description, a time stamp associated with a scene, and location information of the at least one scene.

15. The non-transitory computer readable medium of claim 13, wherein the metadata comprise at least one of device IDs of the plurality of participant devices, participant IDs of a plurality of participants identified in the plurality of image frames, location information and geo-location information associated with the plurality of participant devices, and privacy keys of the plurality of participants.

16. The non-transitory computer readable medium of claim 15, wherein the privacy keys of the plurality of participants are used to authenticate the user for managing content in the database.

17. The non-transitory computer readable medium of claim 13, wherein the retrieving, by the AR system, the set of image frames from the plurality of stored image frames in the database comprises:
detecting, by the AR system, the ID of the user, the information of the at least one scene, and the metadata associated with the plurality of image frames captured by the plurality of participant devices;
determining, by the AR system, a correlation between the information of the at least one scene and the metadata associated with the plurality of image frames based on the ID of the user; and
retrieving, by the AR system, the set of image frames from the database based on the ID of the user and the correlation between the information of the at least one scene and the metadata associated with the plurality of image frames.

18. The non-transitory computer readable medium of claim 13, wherein the generating, by the AR system, the third person AR content view of the user comprises:
authenticating, by the AR system, the received AR content generation request received from the user;
based on authenticating the received AR content generation request, collecting, by the AR system, the set of image frames from the database; and
combining, by the AR system, the set of image frames based on the metadata associated with the set of image frames to generate the third person AR content view of the user.
